(19) United States
(12) Patent Application Publication
(10) Pub. No.: US 2025/0217658 A1
(43) Pub. Date: Jul. 3, 2025

(54) ARTIFICIAL INTELLIGENCE-BASED RECOMMENDATION

(71) Applicant: Tencent Technology (Shenzhen) Company Limited, Shenzhen (CN)

(72) Inventor: Hao CHEN, Shenzhen (CN)

(73) Assignee: Tencent Technology (Shenzhen) Company Limited, Shenzhen, GD (CN)

(21) Appl. No.: 19/080,659

(22) Filed: Mar. 14, 2025

Related U.S. Application Data
(63) Continuation of application No. PCT/CN2023/132290, filed on Nov. 17, 2023.

(30) Foreign Application Priority Data
Feb. 9, 2023 (CN) 202310129956.0

(51) Int. Cl. G06N 3/09; G06F 5/01; G06F 17/16; G06N 3/045

(52) U.S. Cl. CPC G06N 3/09; G06F 5/01; G06F 17/16; G06N 3/045

(57) ABSTRACT

Some aspects of the disclosure provide a method of artificial intelligence-based recommendation. The method includes obtaining an object feature of a target object; obtaining, from a first information item, respective information features in one or more dimensions; performing an attention processing on the respective information features in the one or more dimensions based on the object feature, to obtain weights of the respective information features in the one or more dimensions; performing fusion processing on the respective information features in the one or more dimensions based on the weights of the respective information features in the one or more dimensions, to obtain an attention information feature of the first information item; determining a first feature similarity between the object feature and the attention information feature; and determining, based on the first feature similarity, whether to recommend the first information item to the target object.

### RELATED APPLICATIONS

The present application is a continuation of International Application No. PCT/CN2023/132290, filed on Nov. 17, 2023, which claims priority to Chinese Patent Application No. 202310129956.0, filed on Feb. 9, 2023. The entire disclosures of the prior applications are hereby incorporated by reference.

### FIELD OF THE TECHNOLOGY

This disclosure relates to the field of artificial intelligence technologies, including an artificial intelligence-based recommendation.

### BACKGROUND OF THE DISCLOSURE

Artificial intelligence (AI) is a theory, a method, a technology, and an application system that uses a digital computer or a machine controlled by the digital computer to simulate, extend, and expand human intelligence, perceive an environment, acquire knowledge, and use knowledge to obtain an optimal result.

Recommendation processing is an important application of the artificial intelligence. Recall, as a front end of a recommendation system, determines an upper limit and a lower limit of the entire recommendation system. With the development of deep learning, large-scale labeled deep learning networks are widely promoted and applied at each stage of the recommendation system. In the related art, data related to an object and data related to information are uniformly inputted into a deep neural network for learning and matching, and then recommendation is performed based on a learning and matching result. However, an obtained recommendation evaluation result cannot break through a bottleneck, and cannot effectively match an interest of the object, causing bad experience for the object.

### SUMMARY

Embodiments of this disclosure provide an artificial intelligence-based recommendation processing method and apparatus, an electronic device, a computer-readable storage medium, and a computer program product, which can improve recommendation accuracy.

Some aspects of the disclosure provide a method of artificial intelligence-based recommendation. The method includes obtaining an object feature of a target object; obtaining, from a first information item, respective information features in one or more dimensions; performing an attention processing on the respective information features in the one or more dimensions based on the object feature, to obtain weights of the respective information features in the one or more dimensions; performing fusion processing on the respective information features in the one or more dimensions based on the weights of the respective information features in the one or more dimensions, to obtain an attention information feature of the first information item; determining a first feature similarity between the object feature and the attention information feature; and determining, based on the first feature similarity, whether to recommend the first information item to the target object.

Some aspects of the disclosure provide an apparatus for artificial intelligence-based recommendation. The apparatus includes processing circuitry configured to: obtain an object feature of a target object; obtain, from a first information item, respective information features in one or more dimensions; perform an attention processing on the respective information features in the one or more dimensions based on the object feature, to obtain weights of the respective information features in the one or more dimensions; perform fusion processing on the respective information features in the one or more dimensions based on the weights of the respective information features in the one or more dimensions, to obtain an attention information feature of the first information item; determine a first feature similarity between the object feature and the attention information feature; and determine, based on the first feature similarity, whether to recommend the first information item to the target object.

An embodiment of this disclosure provides an electronic device, including: a memory, configured to store computer-executable instructions; and a processor (e.g., processing circuitry), configured to implement, when executing the computer-executable instructions stored in the memory, the artificial intelligence-based recommendation processing method provided in the embodiments of this disclosure.

An embodiment of this disclosure provides a non-transitory computer-readable storage medium, having computer-executable instructions stored therein, configured for implementing, when executed by a processor, the artificial intelligence-based recommendation processing method provided in the embodiments of this disclosure.

An embodiment of this disclosure provides a computer program product, including computer-executable instructions, the computer-executable instructions, when executed by a processor, implementing the artificial intelligence-based recommendation processing method provided in the embodiments of this disclosure.

The embodiments of this disclosure have the following beneficial effects:

Attention processing is performed on the information feature in each dimension based on the object feature, to obtain the weight of the information feature in each dimension. Through attention processing herein, weights configured for representing degrees of attention of the target object to different dimensions can be obtained. A plurality of information features in dimensions are fused based on the weight of the information feature in each dimension, to obtain the attention information feature of the recommended information. This is equivalent to breaking up and fusing the information features at a dimensional level. The attention information feature obtained through fusion conforms to a requirement of the target object for the degrees of attention to different dimensions, thereby improving a feature expression capability of the recommended information for the target object, and effectively matching an attention dimension of the target object, so that recommendation efficiency and recommendation accuracy can be effectively improved.

### BRIEF DESCRIPTION OF THE DRAWINGS

FIG. 1 is a schematic structural diagram of an artificial intelligence-based recommendation system according to an embodiment of this disclosure.

FIG. 2 is a schematic structural diagram of an electronic device according to an embodiment of this disclosure.

FIG. 3A to FIG. 3C are schematic flowcharts of an artificial intelligence-based recommendation method according to an embodiment of this disclosure.

FIG. 4 is a schematic diagram of an application model of a recommendation model according to an embodiment of this disclosure.

FIG. 5 is a schematic diagram of a training model of an artificial intelligence-based recommendation method according to an embodiment of this disclosure.

### DESCRIPTION OF EMBODIMENTS

The following describes this disclosure in further detail with reference to the accompanying drawings. The described embodiments are not to be considered as a limitation to this disclosure.

In the following descriptions, related “some embodiments” describe a subset of all possible embodiments. However, it may be understood that the “some embodiments” may be the same subset or different subsets of all the possible embodiments, and may be combined with each other without conflict.

In the following descriptions, the included term “first/second/third” is merely intended to distinguish similar objects but does not necessarily indicate specific order of an object. “First/second/third” is interchangeable in terms of a specific order or sequence if permitted, so that the embodiments of this disclosure described herein can be implemented in a sequence in addition to the sequence shown or described herein.

Terms used in this specification are merely intended to describe objectives of the embodiments of this disclosure, but are not intended to limit this disclosure.

Before the embodiments of this disclosure are further described in detail, nouns and terms involved in the embodiments of this disclosure are described. Examples of terms involved in the embodiments of the disclosure are briefly introduced. The descriptions of the terms are provided as examples only and are not intended to limit the scope of the disclosure. The nouns and terms provided in the embodiments of this disclosure are applicable to the following explanations.

(1) Recommendation system: The recommendation system may refer to a tool that automatically connects objects and information. It can help the objects find information that interests the objects in an information overload environment, and can also push the information to an object that is interested in the information.

(2) Recall: Due to limitations of computing power and an online system delay (rt) of a recommendation system, a funnel-level structure of recall-rough sorting (omissible)-fine sorting-strategy (mixed sorting) is generally used in the recommendation system. Recall may be at a front end of the entire system and may be responsible for selecting a subset (of a level of hundreds, thousands, to tens of thousands) that conforms to a goal and the computing power limitation of the system from an entire candidate pool (millions to hundreds of millions). This ensures a lower limit of the recommendation system and directly affects an upper limit of an effect of the recommendation system.

(3) Attention mechanism: Attention mechanism comes from a human visual attention mechanism. Generally, when perceiving a thing through vision, people do not view the whole thing from beginning to end every time, but often observe and pay attention to a specific part according to a requirement. In addition, when people find that a thing they want to observe often appears in a specific part of a scenario, they learn to pay attention to the part when a similar scenario appears in the future, thereby focusing more attention on a useful part.

(4) Target object: Target object may refer to a target on which recommendation processing is performed. Because a medium for information display is a terminal, a target of recommendation processing is a user operating a corresponding terminal. Therefore, “object” and “user” are equivalently described blow. The user herein may be a natural person who can operate the terminal, or may be a robot program that is run in the terminal and can simulate a human being.

(5) Recommended information: It is information that can be transmitted to a terminal for display to be recommended to an object (a target object account) corresponding to the terminal, and is, for example, a video, an item, news, or the like.

For different objects, how to quickly filter out videos that interest the objects the most from massive data directly affects experience of the objects. Because recall is at a front end of a recommendation system, an effect of a recall model plays a decisive role in data distribution of subsequent models such as a rough sorting model, a fine sorting model, and a re-sorting model.

In a dual-tower model technology in the related art, before object information and item information are transmitted into a deep neural network, importance of the object information and the item information is dynamically learned, and noise in an original feature is weakened and filtered out, thereby reducing pollution and loss of information during transmission in the tower. Finally, product recall is performed based on a similarity result. In an interest capsule-based recall technology in the related art, an object feature is inputted, to output a vector representing an object interest. First, an item feature from an input layer is converted into an embedding feature through an embedding layer, and then embedding features of all items are averaged through a pooling layer. Subsequently, an embedding feature representing an object operation is to be transmitted to a multi-interest extraction layer, to generate an interest capsule. Finally, the interest capsule is connected to the embedding feature representing the object operation, to obtain an object representation vector.

For the dual-tower model technology, it can only separately enhance a feature on an object side and a feature on an item side, but it cannot explain which dimension of the feature of the object is enhanced. In addition, a supervised learning training method is also used for calculation on the item side, and information between similar features or dissimilar features cannot be learned from unlabeled data, resulting in inaccurate representation of item information.

For the interest capsule-based recall technology, different interests of an object are modeled in a mode of designing a capsule network. However, which dimension of a feature of the object is enhanced is not explained with reference to the item information. In addition, learning is also performed based on labeled data. However, in the recommendation system, the labeled data accounts for only a small part, and more useful information, namely, more accurate item representation, cannot be obtained from unlabeled data through self-learning. In addition, the interest capsule-based recall technology also focuses on allowing a model to learn similarity of data, rather than learning from a perspective of analyzing dissimilarity of data. This limits an expression capability of the model.

The embodiments of this disclosure provides an artificial intelligence-based recommendation processing method and apparatus, an electronic device, a computer-readable storage medium, and a computer program product. Through attention processing, weights configured for representing degrees of attention of a target object to different dimensions can be obtained. Information features are broken up and fused at a dimensional level. An attention information feature obtained through fusion conforms to a requirement of the target object for the degrees of attention to different dimensions, thereby improving a feature expression capability of recommended information for the target object, and effectively matching an attention dimension of the target object, so that recommendation efficiency and recommendation accuracy can be effectively improved. An exemplary application of the electronic device provided in the embodiments of this disclosure is described below. The electronic device provided in the embodiments of this disclosure may be a server. An exemplary application in which the electronic device is implemented as a server is to be described below.

Referring to FIG. 1, FIG. 1 is a schematic structural diagram of an artificial intelligence-based recommendation processing system according to an embodiment of this disclosure. To support a news application, a terminal 400 is connected to an application server 200-2 through a network 300. The network 300 may be a wide area network, a local area network, or a combination of the two. A training server 200-1 pushes a trained first recommendation model to the application server 200-2. The terminal 400 transmits an object request to the application server 200-2. The application server 200-2 obtains an object feature of a target object, and obtains an information feature of recommended information in each dimension; performs attention processing on the information feature in each dimension based on the object feature, to obtain a weight of the information feature in each dimension; performs fusion processing on a plurality of information features in dimensions based on the weight of the information feature in each dimension, to obtain an attention information feature of the recommended information; and obtains a first feature similarity between the object feature and the attention information feature, and performs, based on the first feature similarity, a recommendation operation corresponding to the recommended information on the target object. In other words, the recommended information is returned to the terminal 400 used by the target object for display.

In some embodiments, the training server 200-1 and the application server 200-2 each may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited in the embodiments of this disclosure.

In some embodiments, the terminal or the server may implement, by running a computer program, the artificial intelligence-based recommendation processing method provided in the embodiments of this disclosure. For example, the computer program may be an original program or a software module in an operating system; may be a native application (APP), namely, a program such as a news APP or an e-commerce APP that needs to be installed in an operating system to run; or may be an applet, namely, a program that only needs to be downloaded into a browser environment to run; or may be an applet that can be embedded into any APP. In conclusion, the foregoing computer program may be any form of an application, a module, or a plug-in.

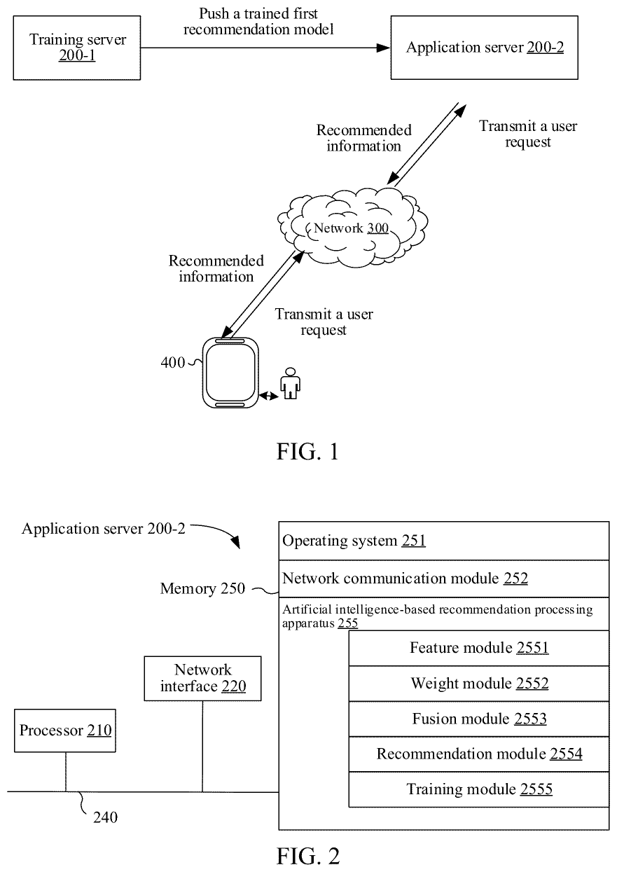

Referring to FIG. 2, FIG. 2 is a schematic structural diagram of an electronic device according to an embodiment of this disclosure. An example in which the electronic device is an application server 200-2 is used. The application server 200-2 shown in FIG. 2 includes: at least one processor 210, a memory 250, at least one network interface 220, and an object interface 230. All the components in the terminal 400 are coupled together by a bus system 240. The bus system 240 is configured to implement connection and communication between the components. In addition to a data bus, the bus system 240 further includes a power bus, a control bus, and a state signal bus. However, for description, all types of buses in FIG. 2 are marked as the bus system 240.

The processor 210 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The memory 250 may be a removable memory, a non-removable memory, or a combination thereof. Exemplary hardware devices include a solid-state memory, a hard disk drive, an optical disc driver, and the like. The memory 250, in some embodiments, includes one or more storage devices physically away from the processor 210.

The memory 250 includes a volatile memory or a non-volatile memory, or may include both a volatile memory and a non-volatile memory. The non-volatile memory may be a read-only memory (ROM). The volatile memory may be a random access memory (RAM). The memory 250 described in this embodiment of this disclosure is to include any other suitable type of memories.

In some embodiments, the memory 250 can store data to support various operations. Examples of the data include a program, a module, and a data structure, or a subset or a superset thereof, which are described below by using examples.

An operating system 251 includes a system program configured to process various basic system services and perform a hardware-related task, such as a framework layer, a core library layer, or a driver layer, and is configured to implement various basic services and process a hardware-based task.

A network communication module 252 is configured to reach another electronic device through one or more (wired or wireless) network interfaces 220. Exemplary network interfaces 220 include: Bluetooth, wireless compatible authentication (Wi-Fi), a universal serial bus (USB), and the like.

In some embodiments, the artificial intelligence-based recommendation processing apparatus provided in the embodiments of this disclosure may be implemented by using software. FIG. 2 shows an artificial intelligence-based recommendation processing apparatus 255 stored in the memory 250. The apparatus may be software in a form such as a program or a plug-in, and includes the following software modules: a feature module 2551, a weight module 2552, a fusion module 2553, a recommendation module 2554, and a training module 2555. The modules are logical modules, and therefore may be randomly combined or further divided based on a function to be performed. The following describes a function of each module.

The artificial intelligence-based recommendation processing method provided in the embodiments of this disclosure is described with reference to an exemplary application and implementation of the application server 200-2 provided in the embodiments of this disclosure.

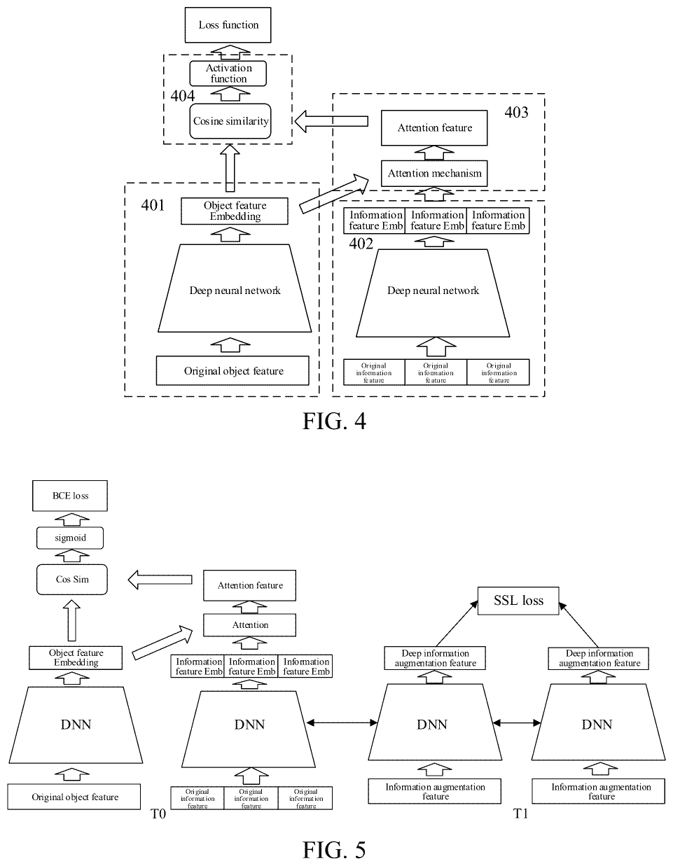

In some embodiments, referring to FIG. 4, FIG. 4 is a schematic model diagram of a recommendation model according to an embodiment of this disclosure. A first recommendation model TO includes an object tower network 401, an information tower network 402, an attention network 403, and a similarity network 404. Input of the object tower network is object data (an original object feature) of a target object, and output of the object tower network is an object feature of the target object. Input of the information tower network is relevant data (an original information feature, including an identifier, a type, attribute data, and the like) of recommended information, and output of the information tower network is an information feature of the recommended information. Input of the attention network is the information feature and the object feature, and output of the attention network is an attention feature. Input of the similarity network is the object feature and the attention feature, and output of the similarity network is a first similarity.

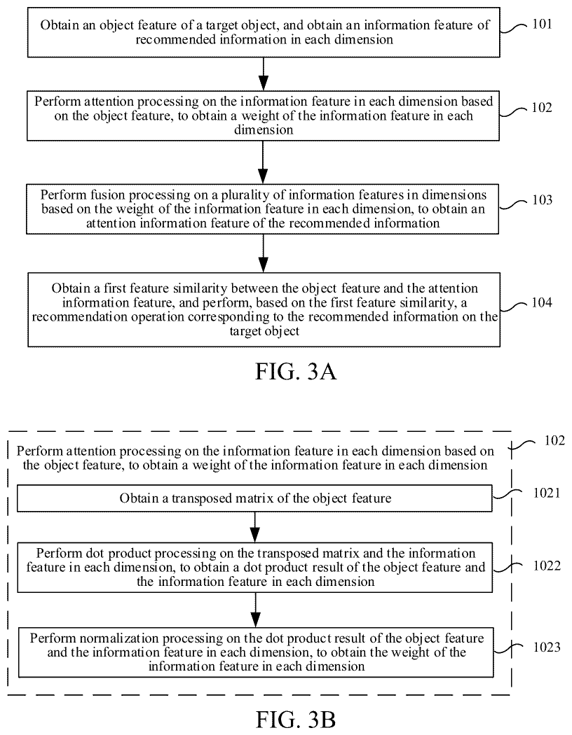

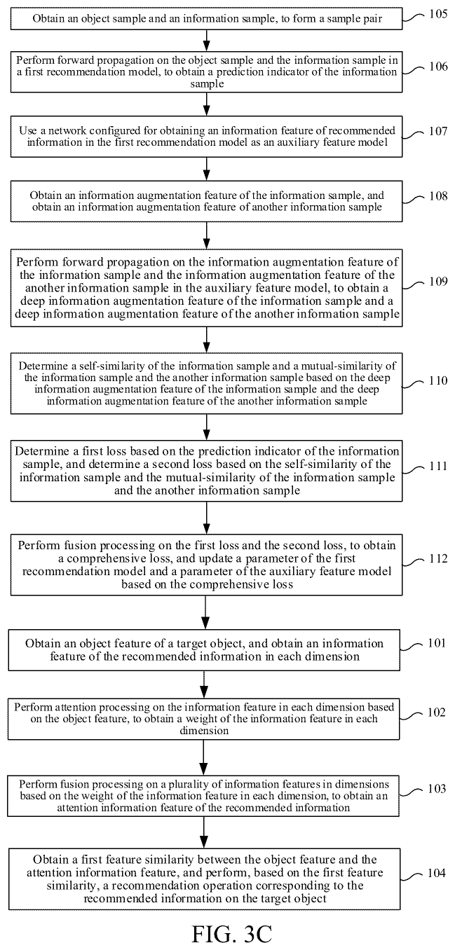

Referring to FIG. 3A, FIG. 3A is a schematic flowchart of an artificial intelligence-based recommendation processing method according to an embodiment of this disclosure. Description is provided with reference to operations 101 to 104 shown in FIG. 3A.

Operation 101: Obtain an object feature of a target object, and obtain an information feature of recommended information (e.g., information item) in each dimension.

In some embodiments, the obtaining an object feature of a target object in Operation 101 may be implemented through the following technical solutions: obtaining object data of the target object; performing compression coding on the object data, to obtain an original object feature of the object data; and performing first full connection processing on the original object feature, to obtain an object feature of the object data. According to the embodiments of this disclosure, a data dimension of the object data may be reduced, thereby improving data storage resource utilization and subsequent computing resource utilization.

As an example, that first full connection processing is performed on the original object feature, to obtain the object feature of the object data may be implemented through the object tower network (a DNN network on a left side of FIG. 4) shown in FIG. 4. The object tower network is actually a deep neural network, and the object data is obtained after object authorization. The object data may be an account level of an object, an operation record of the object, and the like. For the object data of a discrete type, compression coding needs to be performed on the object data of the discrete type, to obtain an original object feature configured for representing the object data. The original object feature may be in a data form of an embedding vector. Then, first full connection processing is performed on the original object feature of the object data through a hidden layer in the deep neural network, to obtain an object feature subsequently configured for performing similarity calculation. The object feature is also in a data form of an embedding vector.

In some embodiments, the obtaining an information feature of recommended information in each dimension in Operation 101 may be implemented through the following technical solutions: obtaining information data that is of the recommended information and that corresponds to each dimension; performing compression coding on the information data in each dimension, to obtain an original information feature in each information dimension; and performing second full connection processing on the original information feature in each information dimension, to obtain an information feature in each information dimension. According to the embodiments of this disclosure, a data dimension of the information data may be reduced, thereby improving data storage resource utilization and subsequent computing resource utilization.

As an example, that second full connection processing is performed on the original information feature in each information dimension, to obtain an information feature in each information dimension may be implemented through the information tower network (a DNN network on a right side of FIG. 4) shown in FIG. 4. The information tower network is actually a deep neural network, and the information data is data configured for describing information. The recommended information may be a video, news, an item, or the like. The information data may be a type of the recommended information, a format of the recommended information, a price of the recommended information, or the like. The information data may be data in different dimensions. For example, when the recommended information is an item, the information data may be configured for representing a price range of the recommended information, and the information data may also be configured for representing an item type of the recommended information. The item type and the price range are two different dimensions. For the discrete data, compression coding needs to be performed on the discrete data, to obtain an original information feature configured for representing the information data. The original information feature may be in a data form of an embedding vector. Then, second full connection processing is performed on the original information feature of the information data through a hidden layer in the deep neural network, to obtain an information feature subsequently configured for performing similarity calculation. The information feature is also in a data form of an embedding vector.

Operation 102: Perform attention processing on the information feature in each dimension based on the object feature, to obtain a weight of the information feature in each dimension.

In some embodiments, referring to FIG. 3B, the performing attention processing on the information feature in each dimension based on the object feature, to obtain a weight of the information feature in each dimension in Operation 102 may be implemented through Operation 1021 to Operation 1023 shown in FIG. 3B.

Operation 1021: Obtain a transposed matrix of the object feature.

As an example, a data form of the object feature may be a matrix A, and the transposed matrix herein is equivalent to a transposed matrix of the matrix A.

Operation 1022: Perform dot product processing on the transposed matrix and the information feature in each dimension, to obtain a dot product result of the object feature and the information feature in each dimension.

As an example, a data form of the information feature in each dimension herein is also a matrix.

Operation 1023: Perform normalization processing on the dot product result of the object feature and the information feature in each dimension, to obtain the weight of the information feature in each dimension.

As an example, an object feature eᵤ^{final} of the target object is used as a query vector in an attention mechanism. An information feature e_{i,f}_{ᵢ}^{output} in each dimension is used as a key vector and a value vector. A dot product of the object feature eᵤ^{final} of the target object and the information feature e_{i,f}_{ᵢ}^{output} in each dimension of an item is calculated, a similarity between the target object and the information feature in each dimension is calculated, and then normalization processing is performed on the calculated similarity through a softmax function, to obtain a weight of each dimension. For the foregoing process, reference may be made to Formula (1):

$${w}_{i , {f}_{i}}^{output} = soft max ( \frac{{e}_{u}^{final T} {e}_{i , {f}_{i}}^{output}}{\sqrt{{d}_{k}}} ) , \qquad ( 1 )$$

where in the foregoing Formula, dₖ is a hyperparameter, eᵤ^{final T} is the transposed matrix of the object feature, e_{i,f}_{ᵢ}^{output} is an information feature of recommended information i in a dimension fᵢ, and w_{i,f}_{ᵢ}^{output} is a weight of the information feature of the recommended information i in the dimension fᵢ.

The feature data of the object is classified by using the attention mechanism, so that a focus to which the object pays attention can be properly controlled and explained during learning of the deep neural network. In addition, after the attention mechanism is added, an attention information feature has a focus conforming to attention of the object, and the recommended information can better conform to an interest of the object.

Operation 103: Perform fusion processing on a plurality of information features in dimensions based on the weight of the information feature in each dimension, to obtain an attention information feature of the recommended information.

As an example, the fusion processing in Operation 103 may be weighted summation processing. Referring to Formula (2):

$${e}_{i}^{final} = {w}_{i , {f}_{i}}^{output} \times {e}_{i , {f}_{i}}^{output} , \qquad ( 2 )$$

where e_{i,f}_{ᵢ}^{output} is an information feature of an item i in the dimension fᵢ, w_{i,f}_{ᵢ}^{output} is the weight of the information feature of the recommended information i in the dimension fᵢ, and eᵢ^{final} is an attention information feature of the recommended information i.

Operation 104: Obtain a first feature similarity between the object feature and the attention information feature, and perform, based on the first feature similarity, a recommendation operation corresponding to the recommended information on the target object.

As an example, a cosine similarity between the attention information feature and the object feature of the target object is determined, and a predicted click-through value ŷ is outputted through a sigmoid function. Referring to Formula (3) and Formula (4):

$$Cos Sim = \frac{{e}_{u}^{final} \cdot {e}_{i}^{final}}{‖ {e}_{u}^{final} ‖ ‖ {e}_{i}^{final} ‖} ; and \qquad ( 3 )$$

$$\hat{y} = sigmoid ( Cos Sim ) , \qquad ( 4 )$$

where CosSim is the cosine similarity, eᵤ^{final} is the object feature, eᵢ^{final} is the attention information feature of the recommended information i, and ŷ is the first feature similarity.

In some embodiments, the performing, based on the first feature similarity, a recommendation operation corresponding to the recommended information on the target object in Operation 104 may be implemented through the following technical solutions: performing any one of the following processing: when the first feature similarity exceeds a first feature similarity threshold, performing the recommendation operation corresponding to the recommended information on the target object; and based on a first feature similarity of each piece of recommended information, sorting a plurality of pieces of recommended information in descending order, obtaining a plurality of pieces of recommended information ranking in the top in a descending-order sorting result as target recommended information, and performing a recommendation operation corresponding to the target recommended information on the target object. According to the embodiments of this disclosure, recommendation accuracy of the recommendation operation can be improved, implementing accurate recommendation for the target object.

As an example, when the first feature similarity exceeds the first feature similarity threshold, it may be determined that the recommended information conforms to the attention of the target object and conforms to the interest of the target object. Therefore, the recommendation operation corresponding to the recommended information is performed on the target object. The recommendation operation herein may be transmitting the recommended information to a client of the target object, or may be transmitting the recommended information to a program for rough sorting and fine sorting. The program for rough sorting and fine sorting may also be considered as a part of the recommendation operation. When there is a plurality of pieces of recommended information, the plurality of pieces of recommended information may be sorted in descending order based on a first feature similarity of each piece of recommended information. A plurality of pieces of recommended information ranking in the top in a descending sorting result, which may be the top 50 pieces of recommended information, are used as the target recommended information, namely, 50 pieces of recommended information having a highest similarity. The recommendation operation herein may be transmitting the target recommended information to the client of the target object, or may be transmitting the target recommended information to the program for rough sorting and fine sorting. The program for rough sorting and fine sorting may also be considered as a part of the recommendation operation.

In some embodiments, referring to FIG. 3C, the recommendation processing method is implemented by using a first recommendation model, and before the obtaining an information feature of recommended information in each dimension, Operation 105 to Operation 112 shown in FIG. 3C may be further performed.

Operation 105: Obtain an object sample and an information sample (also referred to as an information item sample), and use the object sample and the information sample to form a sample pair.

As an example, it is assumed that there are m object samples and n information samples (for example, n items). In this case, there are m×n sample pairs. An i^{th} sample pair pairᵢ=(uᵢ, iᵢ) is used as an example for subsequent description. When there is an interaction relationship between the object sample and the information sample, a label of the sample pair formed by the object sample and the information sample is 1; otherwise, a label of the sample pair formed by the object sample and the information sample is 0.

Operation 106: Perform forward propagation on the object sample and the information sample in the first recommendation model, to obtain a prediction indicator of the information sample.

As an example, for an implementation of the performing forward propagation on the object sample and the information sample in the first recommendation model, to obtain a prediction indicator of the information sample in Operation 106, reference may be made to implementations of Operation 101 to Operation 104.

First, an object feature of the object sample is obtained, and the information feature of the recommended information in each dimension is obtained. Specifically, object data of the object sample is obtained; compression coding is performed on the object data, to obtain an original object feature of the object data; and first full connection processing is performed on the original object feature, to obtain an object feature of the object data. Information data that is of the recommended information and that corresponds to each dimension is obtained; compression coding is performed on the information data in each dimension, to obtain an original information feature in each information dimension; and second full connection processing is performed on the original information feature in each information dimension, to obtain an information feature in each information dimension.

Next, attention processing is performed on an information feature of the information sample in each dimension based on the object feature of the object sample, to obtain a weight of the information feature of the information sample in each dimension. Specifically, the transposed matrix of the object feature is obtained. Dot product processing is performed on the transposed matrix and the information feature in each dimension, to obtain the dot product result of the object feature and the information feature in each dimension. Normalization processing is performed on the dot product result of the object feature and the information feature in each dimension, to obtain the weight of the information feature in each dimension.

Finally, fusion processing is performed on a plurality of information features of the information sample in dimensions based on the weight of the information feature of the information sample in each dimension, to obtain an attention information feature of the information sample. A first feature similarity between the object feature and the attention information feature is obtained as the prediction indicator.

Operation 107: Use a network configured for obtaining the information feature of the recommended information in the first recommendation model as an auxiliary feature model.

As an example, the network configured for obtaining the information feature of the recommended information in the first recommendation model is the information tower network (the DNN network on the right side) shown in FIG. 4. The information tower network is used as the auxiliary feature model configured to perform auxiliary training. The auxiliary feature model herein is independent of the first recommendation model, but a model structure of the auxiliary feature model is the same as a model structure of the first recommendation model.

Operation 108: Obtain an information augmentation feature of the information sample, and obtain an information augmentation feature of another information sample.

In some embodiments, the obtaining an information augmentation feature of the information sample may be implemented through the following technical solutions: obtaining information sample data that is of the information sample and that corresponds to each dimension; and obtaining the information augmentation feature of the information sample based on the information sample data that is of the information sample and that corresponds to each dimension. The obtaining an information augmentation feature of another information sample may be implemented through the following technical solutions: obtaining another information sample data that is of each piece of the another information sample and that corresponds to each dimension; and obtaining the information augmentation feature of each piece of the another information sample based on the another information sample data that is of each piece of the another information sample and that corresponds to each dimension. According to the embodiments of this disclosure, the information augmentation feature may be obtained based on the information sample data, so that data augmentation is implemented, a representation capability of a model is improved.

As an example, the information sample data is data configured for describing the information sample. The information sample may be a video, news, an item, or the like. The information sample data may be a type of the information sample, a mark of the information sample, content of the recommended information, a format of the information sample, a price of the recommended information, or the like. The information sample data may be data in different dimensions. For example, when the information sample is an item, the information sample data is configured for representing a price range of the information sample, and the information sample data may also be configured for representing an item type of the information sample. The item type and the price range are two different dimensions.

As an example, the another information sample data is data configured for describing the another information sample. The another information sample may be a video, news, an item, or the like. The another information sample data may be a type of the another information sample, a mark of the another information sample, content of the recommended information, a format of the another information sample, a price of the recommended information, or the like. The another information sample data may be data in different dimensions. For example, when the another information sample is an item, the another information sample data is configured for representing a price range of the another information sample, and the another information sample data may also be configured for representing an item type of the another information sample. The item type and the price range are two different dimensions.

In some embodiments, the obtaining the information augmentation feature of the information sample based on the information sample data that is of the information sample and that corresponds to each dimension may be implemented through the following technical solutions: obtaining an original information feature of the information sample based on the information sample data that is of the information sample and that corresponds to each dimension; performing first data augmentation processing on the original information feature of the information sample, to obtain a first information augmentation feature of the information sample, and performing second data augmentation processing on the original information feature of the information sample, to obtain a second information augmentation feature of the information sample; and forming the information augmentation feature of the information sample by using the first information augmentation feature and the second information augmentation feature. According to the embodiments of this disclosure, data augmentation can be implemented twice, so that features obtained through the two times of data augmentation are similar but different, and difficulty in feature learning of a model is increased, thereby improving a training effect of the model.

In some embodiments, the obtaining the information augmentation feature of each piece of the another information sample based on the another information sample data that is of each piece of the another information sample and that corresponds to each dimension may be implemented through the following technical solutions: obtaining an original information feature of each another information sample based on the another information sample data that is of each another information sample and that corresponds to each dimension; and performing the following processing for each another information sample: performing first data augmentation processing on the original information feature of the another information sample, to obtain a third information augmentation feature of the another information sample as the information augmentation feature of the another information sample. According to the embodiments of this disclosure, the third information augmentation feature of the another information sample is obtained through learning, so that the model can identify a feature difference between different information samples, thereby improving a training effect of the model.

As an example, for discrete data such as the information sample data, compression coding needs to be performed on the discrete data, to obtain the original information feature configured for representing the information sample. The original information feature herein may be in a data form of an embedding vector. For discrete data such as the another information sample data, compression coding needs to be performed on the discrete data, to obtain the original information feature configured for representing the another information sample. The original information feature herein may be in a data form of an embedding vector. For the original information feature of the information sample, data augmentation is performed in two manners to obtain the first information augmentation feature and the second information augmentation feature, to form the information augmentation feature of the information sample. For the original information feature of the another information sample, data augmentation is performed in one of the foregoing two manners to obtain the third information augmentation feature as the information augmentation feature of the another information sample.

In some embodiments, the performing first data augmentation processing on the original information feature of the information sample, to obtain a first information augmentation feature of the information sample may be implemented through the following technical solutions: randomly obtaining a seed dimension from a plurality of dimensions, and obtaining a dimension similarity between each another dimension and the seed dimension; sorting the another dimension in descending order based on the dimension similarity, and using a plurality of dimensions ranking in the top in a sorting result and the seed dimension as masking dimensions of the information sample; performing the following processing for each of the masking dimensions of the information sample: determining a masking result of an information feature of the masking dimension based on a first probability; when the masking result represents that the information feature of the masking dimension is discarded, performing deletion on the information feature of the masking dimension; and using an information feature obtained after deletion as the first information augmentation feature of the information sample.

As an example, similarities between all dimensions may be calculated in advance. For example, a similarity between two dimensions, namely, a price range and a price, is higher than a similarity between two dimensions, namely, a price range and an item specification. During masking, a seed dimension f_{seed} is randomly selected from all dimension features F={f₁, f₂ . . . fₙ}, and then dimensions most similar to f_{seed} form a to-be-masked dimension set Fₘ={f₁, f₂ . . . fₖ, f_{seed}}. When a dimension quantity k of the to-be-masked dimensions is decided,

$$k = ⌊ \frac{n}{2} ⌋$$

is selected. In this way, a quantity of masking dimensions and a quantity of remaining dimensions may be roughly equal. At a discarding stage, for each masking dimension, there is a first probability for discarding a feature value in the dimension to increase difficulty in contrastive learning, thereby enhancing an implementation effect of the model. The first probability herein is a fixed preset value, and different first probabilities are correspondingly used in different data augmentation processing.

For a manner of obtaining the third information augmentation feature, reference may be made to a manner of obtaining the first information augmentation feature, because first data augmentation processing is used in both cases. A difference between second data augmentation processing and first data augmentation processing lies in a difference in the randomly obtained seed dimension and a difference in the first probability.

Operation 109: Perform forward propagation on the information augmentation feature of the information sample and the information augmentation feature of the another information sample in the auxiliary feature model, to obtain a deep information augmentation feature of the information sample and a deep information augmentation feature of the another information sample.

As an example, a first information augmentation feature yᵢ₁ of the information sample and a second information augmentation feature yᵢ₂ of the information sample are inputted into the auxiliary feature model for learning, to obtain a first deep information augmentation feature zᵢ₁ of the information sample and a second deep information augmentation feature zᵢ₂ of the information sample. Referring to Formula (5) and Formula (6):

$${z}_{i 1} = DNN ( {y}_{i 1} ) ; and \qquad ( 5 )$$

$${z}_{i 2} = DNN ( {y}_{i 2} ) , \qquad ( 6 )$$

where zᵢ₁ is the first deep information augmentation feature of the information sample, zᵢ₂ is the second deep information augmentation feature of the information sample, yᵢ₁ is the first information augmentation feature of the information sample, yᵢ₂ is the second information augmentation feature of the information sample, and DNN represents the auxiliary feature model.

As an example, a third information augmentation feature yⱼ₁ of the another information sample is inputted into the auxiliary feature model for learning, to obtain a third deep information augmentation feature zⱼ₁ of the another information sample. Referring to Formula (7):
(7):

$${z}_{j 1} = DNN ( {y}_{j 1} ) , \qquad ( 7 )$$

zⱼ₁ is the third deep information augmentation feature of the another information sample, yⱼ₁ is the third information augmentation feature of the another information sample, and DNN represents the auxiliary feature model.

Operation 110: Determine a self-similarity of the information sample and a mutual-similarity of the information sample and the another information sample based on the deep information augmentation feature of the information sample and the deep information augmentation feature of the another information sample.

In some embodiments, the determining a self-similarity of the information sample and a mutual-similarity of the information sample and the another information sample based on the deep information augmentation feature of the information sample and the deep information augmentation feature of the another information sample in Operation 110 may be implemented through the following technical solutions: determining the self-similarity of the information sample based on the deep information augmentation feature of the information sample; and determining the mutual-similarity of the information sample and the another information sample based on the deep information augmentation feature of the information sample and the deep information augmentation feature of the another information sample. According to the embodiments of this disclosure, a contrastive learning mechanism may be introduced on an information side, information sample data without a label can be learned in different data augmentation manners, and an information feature representation capability can be enhanced, so that recommendation is more accurate.

In some embodiments, the deep information augmentation feature of the information sample includes a first deep information augmentation feature and a second deep information augmentation feature; and the determining the self-similarity of the information sample based on the deep information augmentation feature of the information sample may be implemented through the following technical solutions: obtaining a first cosine similarity between the first deep information augmentation feature and the second deep information augmentation feature; and obtaining a self-similarity positively correlated with the first cosine similarity.

As an example, for a manner of calculating the first cosine similarity, reference may be made to Formula (8):

$$s ( {z}_{i 1} , {z}_{i 2} ) = \frac{< {z}_{i 1} , {z}_{i 2} >}{‖ {z}_{i 1} ‖ \cdot ‖ {z}_{i 2} ‖} , \qquad ( 8 )$$

where s(zᵢ₁, zᵢ₂) is a first cosine similarity of an information sample i, zᵢ₁ is a first deep information augmentation feature, and zᵢ₂ is a second deep information augmentation feature.

In some embodiments, the deep information augmentation feature of the information sample includes a first deep information augmentation feature; the deep information augmentation feature of the another information sample includes a third deep information augmentation feature; and the determining the mutual-similarity of the information sample and the another information sample based on the deep information augmentation feature of the information sample and the deep information augmentation feature of the another information sample may be implemented through the following technical solutions: performing the following processing for each another information sample: obtaining a second cosine similarity between the first deep information augmentation feature of the information sample and the third deep information augmentation feature of the another information sample; and obtaining a mutual-similarity positively correlated with the second cosine similarity. According to the embodiments of this disclosure, interpretability of the similarity can be improved, so that a loss function has interpretability. In this case, during training, a training effect can be controlled.

As an example, for a manner of calculating the second cosine similarity, reference may be made to Formula (9):

$$s ( {z}_{i 1} , {z}_{j 1} ) = \frac{〈 {z}_{i 1} , {z}_{j 1} 〉}{‖ {z}_{i 1} ‖ \cdot ‖ {z}_{j 1} ‖} , \qquad ( 9 )$$

where s(zᵢ₁, zⱼ₁) is a second cosine similarity between a first deep information augmentation feature of the information sample i and a third deep information augmentation feature of another information sample j, zᵢ₁ is the first deep information augmentation feature, and zⱼ₁ is the third deep information augmentation feature.

Operation 111: Determine a first loss based on the prediction indicator of the information sample, and determine a second loss based on the self-similarity of the information sample and the mutual-similarity of the information sample and the another information sample.

In some embodiments, the determining a first loss based on the prediction indicator of the information sample in Operation 111 may be implemented through the following technical solutions: obtaining a label indicator of the information sample; and performing cross-entropy processing on the label indicator and the prediction indicator, to obtain the first loss.

As an example, for a manner of calculating the first loss, reference may be made to Formula (10):

$${Loss}_{BCE} = - ( y log ( \hat{y} ) + ( 1 - y ) log ( 1 + \hat{y} ) ) , \qquad ( 10 )$$

where a label indicator y of an information sample with a high mark (higher than a set threshold) given by an object is set to 1; otherwise, the label indicator y of the information sample is set to 0, LOSS_{BCE} is a first loss, and ŷ is a prediction indicator.

In some embodiments, the determining a second loss based on the self-similarity of the information sample and the mutual-similarity of the information sample and the another information sample in Operation 111 may be implemented through the following technical solutions: performing the following processing for each information sample: performing summation processing on a plurality of mutual-similarities of the information sample and the another information sample, to obtain a first summation result corresponding to the information sample; obtaining a ratio positively correlated with the self-similarity of the information sample and negatively correlated with the first summation result; and performing fusion processing on a plurality of ratios of the information sample, to obtain a first fusion result, and obtaining the second loss negatively correlated with the first fusion result.

As an example, for a manner of calculating the second loss, reference may be made to Formula (11):

$${Loss}_{self} ( {x}_{i} ) = - \frac{1}{N} {\sum }_{i ∈ [ N ]} log \frac{exp ( s ( {z}_{i 1} , {z}_{i 2} ) / τ )}{{\sum }_{j ∈ [ N ]} exp ( s ( {z}_{i 1} , {z}_{j 1} ) ) / τ} , \qquad ( 11 )$$

where Loss_{self} (xᵢ) is a second loss, N is a quantity of information samples, exp(s(zᵢ₁, zᵢ₂)/τ) is a self-similarity of the information sample i, exp(s(zᵢ₁, zⱼ₁))/τ is a mutual-similarity of the information sample i and the another information sample j, and Σ_{j∈[N]}exp(s(zᵢ₁, zⱼ₁))/τ is a first summation result corresponding to the information sample i.

Operation 112: Perform fusion processing on the first loss and the second loss, to obtain a comprehensive loss, and update a parameter of the first recommendation model and a parameter of the auxiliary feature model based on the comprehensive loss.

Attention processing is performed on the information feature in each dimension based on the object feature, to obtain the weight of the information feature in each dimension. Through attention processing herein, weights configured for representing degrees of attention of the target object to different dimensions can be obtained. A plurality of information features in dimensions are fused based on the weight of the information feature in each dimension, to obtain the attention information feature of the recommended information. This is equivalent to breaking up and fusing the information features at a dimensional level. The attention information feature obtained through fusion conforms to a requirement of the target object for the degrees of attention to different dimensions, thereby improving a feature expression capability of the recommended information for the target object, and effectively matching an attention dimension of the target object, so that recommendation efficiency and recommendation accuracy can be effectively improved.

The following describes exemplary application of this embodiment of this disclosure in an actual application scenario.

To support a news application, a terminal is connected to an application server through a network. The network may be a wide area network, a local area network, or a combination of the two. A training server pushes a trained first recommendation model to the application server. The terminal transmits an object request to the application server. The application server obtains an object feature of a target object, and obtains an information feature of recommended information in each dimension; performs attention processing on the information feature in each dimension based on the object feature, to obtain a weight of the information feature in each dimension; performs fusion processing on a plurality of information features in dimensions based on the weight of the information feature in each dimension, to obtain an attention information feature of the recommended information; and obtains a first feature similarity between the object feature and the attention information feature, and performs, based on the first feature similarity, a recommendation operation corresponding to the recommended information on the target object. In other words, the recommended information is returned to the terminal used by the target object for display.

The embodiments of this disclosure resolve how to learn, in data with a few labels, a more accurate information feature from data without a label by using contrastive learning and multitask learning modes, classify the focus of the target object by using the attention mechanism, and perform targeted recommendation by using the focus of the target object, so that final recommendation is more accurate.

The embodiments of this disclosure include the following several modules: an attention module, a contrastive learning module, and an auxiliary task learning module. The attention module adjusts a weight difference between different item features based on the object feature, to obtain a more accurate representation of an item feature. The contrastive learning module performs self-learning on the data without a label by data augmentation, enhancing a distinction degree of the item feature. The auxiliary task learning module may flow learned knowledge from an auxiliary task to a primary task. Compared with a case with merely the primary task, a more accurate first recommendation model is easily learned, so that a recommendation result is more effective.

Referring to FIG. 5, a training stage of the embodiments of this disclosure involves two dual-tower models, which are respectively a first recommendation model TO and an auxiliary feature model T1. Compared with a dual-tower model in the related art, the attention mechanism is added in T0, so that an item feature that better conforms to the focus of the object can be obtained. T1 is an auxiliary task model that is trained by contrastive learning and that is introduced to optimize the primary task. At an application stage, the first recommendation model TO is used.

First, how to obtain different focuses of different objects by feature engineering and the attention mechanism, to cause the item feature better conforms to an object requirement, and to cause similarity calculation for the item feature and the object feature to be more proper is described.

A training sample includes object data of all target objects and item data of all items. Object data of a target object is encoded to obtain an input feature vector eᵤ^{input} of the target object. The input feature vector eᵤ^{input} obtained after encoding is inputted into a network corresponding to the target object to obtain an object feature eᵤ^{final} of the target object. Item features may be classified according to different focuses, for example, may be classified according to “interest types (such as delicacy food, animal, and sports)” and “attribute types (such as age, gender, and native place)”, so that all the item features may be classified into n dimensions, and features in these dimensions are spliced to obtain an input feature of an item. When the input feature is constructed, code of a dimension having longest data is used (it is assumed that a length is m). When an encoding length in a dimension is insufficient, feature encoding in each dimension is padded by using 0, to obtain a feature input with an equal length in each dimension. For an i^{th} item, an input feature of each dimension is e_{i,fi}^{input}∈ [symbol] ^{m}. The features in different dimensions are spliced, and an i^{th} item feature vector eᵢ^{input}∈ [symbol] ⁿⁿ is generated at an input end. Referring to Formula (12):

[symbol]

$${e}_{i}^{input} = {e}_{i , {f}_{1}}^{input} ‖ {e}_{i , {f}_{2}}^{input} ‖ … ‖ {e}_{i , {f}_{n}}^{input} , \qquad ( 12 )$$

where eᵢ^{1nput} is an original item feature of an item i, and e_{i,f}_{ₙ}^{input} is an original item feature of the item i in a dimension n.

An input feature eᵢ^{input} is inputted into a network (the DNN network shown on the right side of FIG. 4) corresponding to the item, to obtain an item feature e_{i,fi}^{output}∈ [symbol] ^{d} of the item in each dimension. For an item feature vector of the item, refer to Formula (13):

$${e}_{i}^{output} = {e}_{i , {f}_{1}}^{output} ‖ {e}_{i , {f}_{2}}^{ouotput} ‖ … ‖ {e}_{i , {f}_{n}}^{output} , \qquad ( 13 )$$

where eᵢ^{output} is an item feature of the item i, and e_{i,f}_{ₙ}^{output} is an item feature of the item i in the dimension n.

An object feature eᵤ^{final} of the target object is used as a query vector in the attention mechanism, and the item feature e_{i,f}_{ᵢ}^{ouput} in each dimension is used as a key vector and a value vector. A dot product of the object feature eᵤ^{final} of the target object and the item feature e_{i,f}_{ᵢ}^{ouput} in each dimension of the item is calculated, a similarity between the target object and the item feature in each dimension is calculated, and then normalization processing is performed on the calculated similarity through the softmax function, to obtain a weight of each dimension. After the item feature in each dimension is multiplied by a corresponding weight, a plurality of item features in dimensions are correspondingly added to obtain a final attention feature marked as eᵢ^{final}∈ [symbol] ^{d} of the item. For the foregoing process, reference may be made to Formula (14):

$${e}_{i}^{final} = softmax ( \frac{{e}_{u}^{final T} {e}_{i , {f}_{i}}^{output}}{\sqrt{{d}_{k}}} ) \times {e}_{i , {f}_{i}}^{output} , \qquad ( 14 )$$

where dₖ is a hyperparameter, eᵤ^{final T} is the transposed matrix of the object feature, e_{i,f}_{ᵢ}^{ouput} is an item feature of the item i in a dimension fᵢ, and w_{i,f}_{ᵢ}^{ouput} is a weight of the information feature of the item information i in the dimension fᵢ.

Subsequently, a cosine similarity between the item feature and the object feature of the target object is determined, and a predicted click-through value ŷ is outputted through a sigmoid function. Referring to Formula (15) and Formula (16):

$$CosSim = \frac{{e}_{u}^{final} \cdot {e}_{i}^{final}}{‖ {e}_{u}^{final} ‖ ‖ {e}_{i}^{final} ‖} ; \\ and \qquad ( 15 )$$

$$\hat{y} = sigmoid ( CosSim ) , \qquad ( 16 )$$

where CosSim is the cosine similarity, eᵤ^{final} is the object feature, eᵢ^{final} is the attention information feature of the item i, and ŷ is the first feature similarity (the prediction indicator).

An item label y with a high mark (higher than a set threshold) given by an object is set to 1, a label y of a remaining item is set to 0, and training based on a binary cross-entropy loss function is performed until the binary cross-entropy loss function converges. Referring to Formula (17):

$${Loss}_{BCE} = - ( y log ( \hat{y} ) + ( 1 - y ) log ( 1 + \hat{y} ) ) , \qquad ( 17 )$$

where the label indicator y of the item with a high mark (higher than the set threshold) given by the object is set to 1; otherwise, the label indicator y of the item is set to 0, LOSS_{BCE} is a binary cross-entropy loss, and ŷ is the prediction indicator.

The following continues to describe how to learn a more distinguishable feature of the item from the data without a label by using a contrastive learning method.

A deep neural network in the auxiliary feature model T1 shares a parameter with a deep neural network of a corresponding item in the first recommendation model T0. A key lies in that input data of T1 is different from input data of T0. The input data of the T1 model is obtained from the input data of T0 in different data augmentation manners.

Each data augmentation process mainly involves a masking operation and a discarding operation. The masking operation is to mask features similar to each other, to avoid affecting a training effect of a model. Therefore, a similarity MI between two features, namely, vᵢ and vⱼ, needs to be defined. Referring to Formula (18):

$$MI ( {v}_{i} , {v}_{j} ) P ( {v}_{i} , {v}_{j} ) log \frac{P ( {v}_{i} , {v}_{j} )}{P ( {v}_{i} ) P ( {v}_{j} )} , \qquad ( 18 )$$

where based on Formula (18), similarities between all dimensions may be calculated in advance. During masking, a seed dimension f_{seed} is randomly selected from all dimension features F={f₁, f₂ . . . fₙ}, and then dimensions most similar to f_{seed} form a to-be-masked dimension set Fₘ={f₁, f₂ . . . fₖ, f_{seed}}. When a dimension quantity k of the to-be-masked dimensions is decided,

$$k = ⌊ \frac{n}{2} ⌋$$

is selected. In this way, a quantity of masking dimensions and a quantity of remaining dimensions may be roughly equal. At the discarding stage, for each masking dimension, there is a fixed probability for discarding a feature value in the dimension to increase difficulty in contrastive learning, thereby enhancing an implementation effect of the model.

Based on data augmentation, because T1 is expected to learn a more distinguishable item feature from the data without a label, each item xᵢ is processed in two different data augmentation manners aug₁ and aug₂ to obtain yᵢ₁ and yᵢ₂. Referring to Formula (19) and Formula (20):

$${y}_{i 1} = {aug}_{1} ( {x}_{i} ) ; \\ and \qquad ( 19 )$$

$${y}_{i 2} = {aug}_{2} ( {x}_{i} ) , \qquad ( 20 )$$

where yᵢ₁ is a first item augmentation feature of the item i, yᵢ₂ is a second item augmentation feature of the item i, and xᵢ is an item feature of the item i.

Subsequently, the item features yᵢ₁ and yᵢ₂ obtained after augmentation is inputted into two deep neural networks in the T1 model for learning, to obtain augmented deep features zᵢ₁ and zᵢ₂. Referring to Formula (21) and Formula (22):

$${z}_{i 1} = DNN ( {y}_{i 1} ) ; \\ and \qquad ( 21 )$$

$${z}_{i 2} = DNN ( {y}_{i 2} ) , \qquad ( 22 )$$

where zᵢ₁ is a first deep item augmentation feature of the item i, zᵢ₂ is a second deep item augmentation feature of the item i, yᵢ₁ is the first item augmentation feature of the item i, yᵢ₂ is the second item augmentation feature of the item i, and DNN represents the auxiliary feature model.

A similarity s(zᵢ₁, zᵢ₂) of the augmented deep features zᵢ₁ and zᵢ₂ is defined through Formula (23):

$$s ( {z}_{i 1} , {z}_{i 2} ) = \frac{〈 {z}_{i 1} , {z}_{i 2} 〉}{‖ {z}_{i 1} ‖ \cdot ‖ {z}_{i 2} ‖} , \qquad ( 23 )$$

where s(zᵢ₁, zⱼ₁) is a second cosine similarity between the first deep item augmentation feature of the item i and a third deep item augmentation feature of another item j, zᵢ₁ is the first deep item augmentation feature, and zⱼ₁ is the third deep item augmentation feature.

Because both zᵢ₁ and zᵢ₂ are obtained from the same xᵢ after different data augmentation, the similarity between the two is to be as large as possible. However, for data zⱼ₁ obtained after augmentation of another item in a same training batch, because items are different, a similarity thereof is to be as small as possible. Based on this, a loss function Loss_{self} of contrastive learning may be defined as follows. Referring to Formula (24):

$${Loss}_{self} ( {x}_{i} ) = - \frac{1}{N} {\sum }_{i ∈ [ N ]} log \frac{exp ( s ( {z}_{i 1} , {z}_{i 2} ) / τ )}{{\sum }_{j ∈ [ N ]} exp ( s ( {z}_{i 1} , {z}_{j 1} ) ) / τ} , \qquad ( 24 )$$

where τ is a temperature coefficient hyperparameter, Loss_{self}(xᵢ) is a contrastive loss, N is a quantity of items, exp(s(zᵢ₁, zᵢ₂)/τ) is a self-similarity of the item i, exp(s(zᵢ₁, zⱼ₁))/τ is a mutual-similarity of the item i and the another item j, and Σ_{j∈[N]}exp(s(zᵢ₁, zⱼ₁))/τ is a first summation result corresponding to the item i.

The following describes an overall training process of T0 and T1 based on auxiliary task learning. By introducing an auxiliary task learning manner, contrastive learning is used as an auxiliary task of a primary recall task, and joint optimization is performed. Useful knowledge learned in the contrastive learning is flowed to a primary task in a multitask learning mode, finally achieving a better recommendation effect of the primary task.

The target object and the item are used to form a sample pair. It is assumed that there are m target objects, n items, and therefore m×n sample pairs. An i^{th} sample pair is used as an example for description. An input of the primary recall task is pairᵢ, an input of a contrastive learning task is iᵢ in the sample pair. A loss function Loss at an overall training stage is a combined Loss. Referring to Formula (25):

$$Loss = {Loss}_{BCE} ( {pair}_{i} ) + α \cdot {Loss}_{self} ( {i}_{i} ) , \qquad ( 25 )$$

where α is a hyperparameter, configured for adjusting an auxiliary contrastive learning task weight.

The following describes a main process at the application stage, and the T0 model is mainly used at the application stage. First, all data of an item may be learned offline in advance as item features, and is stored in a vector database in a form of embedding features. An i^{th} item is used as an example, for an online target object, by using a deep neural network corresponding to the target object in the T0 model, an object feature (a form of an embedding feature) of the target object is calculated to be eᵤ^{final}. Then, attention mechanism calculation of a T0 tower are performed on eᵤ^{final} obtained after calculation online and eᵢ^{output} stored in advance, to obtain a more accurate eᵢ^{final}. After eᵢ^{final} and eᵤ^{final} are obtained, a cosine similarity CosSim between the two can be obtained. Finally, similarity sorting is performed on calculated CosSim, and a specific quantity of items having higher similarity scores are selected for recall.

According to the embodiments of this disclosure, interest feature data of the object is classified by using the attention mechanism, so that a focus to which the object pays attention can be properly controlled and explained during learning of the deep neural network. In addition, after the attention mechanism is added, an item feature has a focus conforming to attention of the object, and a recommended item can better conform to an interest of the object. Second, a contrastive learning mechanism is introduced on an item side. In this way, item data without a label can be learned in different data augmentation manners, and an item feature representation capability can be enhanced, so that recommendation is more accurate. Finally, an auxiliary task learning manner is introduced. In this way, knowledge transfer in recall and contrastive learning is implemented in joint training with a primary task, thereby improving a final result of an online server end.

In the embodiments of this disclosure, related data such as user information is involved. When the embodiments of this disclosure are applied to a specific product or technology, user permission or consent is required to be obtained, and relevant collection, use, and processing of data are required to comply with relevant laws, regulations, and standards of relevant countries and regions.

The following continues to describe an exemplary structure of an artificial intelligence-based recommendation processing apparatus 255 implemented as a software module according to an embodiment of this disclosure. In some embodiments, as shown in FIG. 2, a software module stored in the artificial intelligence-based recommendation processing apparatus 255 of a memory 250 may include: a feature module 2551, configured to obtain an object feature of a target object, and obtain an information feature of recommended information in each dimension; a weight module 2552, configured to perform attention processing on the information feature in each dimension based on the object feature, to obtain a weight of the information feature in each dimension; a fusion module 2553, configured to perform fusion processing on a plurality of information features in dimensions based on the weight of the information feature in each dimension, to obtain an attention information feature of the recommended information; and a recommendation module 2554, configured to obtain a first feature similarity between the object feature and the attention information feature, and perform, based on the first feature similarity, a recommendation operation corresponding to the recommended information on the target object.

In some embodiments, the feature module 2551 is further configured to: obtain object data of the target object; perform compression coding on the object data, to obtain an original object feature of the object data; and perform first full connection processing on the original object feature, to obtain an object feature of the object data.

In some embodiments, the feature module 2551 is further configured to: obtain information data that is of the recommended information and that corresponds to each dimension; perform compression coding on the information data in each dimension, to obtain an original information feature in each information dimension; and perform second full connection processing on the original information feature in each information dimension, to obtain an information feature in each information dimension.

In some embodiments, the weight module 2552 is further configured to: obtain a transposed matrix of the object feature; perform dot product processing on the transposed matrix and the information feature in each dimension, to obtain a dot product result of the object feature and the information feature in each dimension; and perform normalization processing on the dot product result of the object feature and the information feature in each dimension, to obtain the weight of the information feature in each dimension.

In some embodiments, the recommendation module 2554 is further configured to: perform any one of the following processing: when the first feature similarity exceeds a first feature similarity threshold, performing the recommendation operation corresponding to the recommended information on the target object; and based on a first feature similarity of each piece of recommended information, sorting a plurality of pieces of recommended information in descending order, obtaining a plurality of pieces of recommended information ranking in the top in a descending-order sorting result as target recommended information, and performing a recommendation operation corresponding to the target recommended information on the target object.

In some embodiments, the apparatus further includes: a training module 2555, further configured to: obtain an object sample and an information sample, and use the object sample and the information sample to form a sample pair; perform forward propagation on the sample pair in the first recommendation model, to obtain a prediction indicator of the information sample; use a network configured for obtaining the information feature of the recommended information in the first recommendation model as an auxiliary feature model; obtain an information augmentation feature of the information sample, and obtain an information augmentation feature of another information sample; perform forward propagation on the information augmentation feature of the information sample and the information augmentation feature of the another information sample in the auxiliary feature model, to obtain a deep information augmentation feature of the information sample and a deep information augmentation feature of the another information sample; determine a self-similarity of the information sample and a mutual-similarity of the information sample and the another information sample based on the deep information augmentation feature of the information sample and the deep information augmentation feature of the another information sample; determine a first loss based on the prediction indicator of the information sample, and determine a second loss based on the self-similarity of the information sample and the mutual-similarity of the information sample and the another information sample; and perform fusion processing on the first loss and the second loss, to obtain a comprehensive loss, and update a parameter of the first recommendation model and a parameter of the auxiliary feature model based on the comprehensive loss.

In some embodiments, the training module 2555 is further configured to: obtain a label indicator of the information sample; and perform cross-entropy processing on the label indicator and the prediction indicator, to obtain the first loss.

In some embodiments, the training module 2555 is further configured to: perform the following processing for each information sample: performing summation processing on a plurality of mutual-similarities of the information sample and the another information sample, to obtain a first summation result corresponding to the information sample; obtaining a ratio positively correlated with the self-similarity of the information sample and negatively correlated with the first summation result; and performing fusion processing on a plurality of ratios of the information sample, to obtain a first fusion result, and obtaining the second loss negatively correlated with the first fusion result.

In some embodiments, the training module 2555 is further configured to: obtain information sample data that is of the information sample and that corresponds to each dimension; and obtain the information augmentation feature of the information sample based on the information sample data that is of the information sample and that corresponds to each dimension; obtain another information sample data that is of each another information sample and that corresponds to each dimension; and obtain the information augmentation feature of each piece of the another information sample based on the another information sample data that is of each piece of the another information sample and that corresponds to each dimension.

In some embodiments, the information augmentation feature of the information sample includes a first information augmentation feature and a second information augmentation feature; and the training module 2555 is further configured to: obtain a first cosine similarity between the first information augmentation feature and the second information augmentation feature; and obtain a self-similarity positively correlated with the first cosine similarity.

In some embodiments, the deep information augmentation feature of the information sample includes a first information augmentation feature; the deep information augmentation feature of the another information sample includes a third information augmentation feature; and the training module 2555 is further configured to: perform the following processing for each another information sample: obtaining a second cosine similarity between the first information augmentation feature of the information sample and the third information augmentation feature of the another information sample; and obtaining a mutual-similarity positively correlated with the second cosine similarity.

In some embodiments, the training module 2555 is further configured to: obtain an original information feature of the information sample based on the information sample data that is of the information sample and that corresponds to each dimension; perform first data augmentation processing on the original information feature of the information sample, to obtain a first information augmentation feature of the information sample, and perform second data augmentation processing on the original information feature of the information sample, to obtain a second information augmentation feature of the information sample; and form the information augmentation feature of the information sample by using the first information augmentation feature and the second information augmentation feature.

In some embodiments, the training module 2555 is further configured to: obtain an original information feature of each another information sample based on the another information sample data that is of each another information sample and that corresponds to each dimension; and perform the following processing for each another information sample: performing first data augmentation processing on the original information feature of the another information sample, to obtain a third information augmentation feature of the another information sample as the information augmentation feature of the another information sample.

In some embodiments, the training module 2555 is further configured to: randomly obtain a seed dimension from a plurality of dimensions, and obtain a dimension similarity between each another dimension and the seed dimension; sort the another dimension in descending order based on the dimension similarity, and use a plurality of dimensions ranking in the top in a sorting result and the seed dimension as masking dimensions of the information sample; and perform the following processing for each of the masking dimensions of the information sample: determining a masking result of an information feature of the masking dimension based on a first probability; when the masking result represents that the information feature of the masking dimension is discarded, performing deletion on the information feature of the masking dimension; and using an information feature obtained after deletion as the first information augmentation feature of the information sample.

An embodiment of this disclosure provides a computer program product, including computer-executable instructions, the computer-executable instructions being stored in a computer-readable storage medium. A processor (e.g., processing circuitry) of an electronic device reads the computer-executable instructions from the computer-readable storage medium, and executes the computer-executable instructions, to cause the electronic device to perform the artificial intelligence-based recommendation processing method provided in the embodiments of this disclosure.

An embodiment of this disclosure provides a non-transitory computer-readable storage medium, having computer-executable instructions stored therein, the computer-executable instructions, when executed by a processor, causing the processor to perform the artificial intelligence-based recommendation processing method, for example, the artificial intelligence-based recommendation processing method shown in FIG. 3A to FIG. 3C, provided in the embodiments of this disclosure.

In some embodiments, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some embodiments, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In various examples, attention processing is performed on the information feature in each dimension based on the object feature, to obtain the weight of the information feature in each dimension. Through attention processing herein, weights configured for representing degrees of attention of the target object to different dimensions can be obtained. A plurality of information features in dimensions are fused based on the weight of the information feature in each dimension, to obtain the attention information feature of the recommended information. This is equivalent to breaking up and fusing the information features at a dimensional level. The attention information feature obtained through fusion conforms to a requirement of the target object for the degrees of attention to different dimensions, thereby improving a feature expression capability of the recommended information for the target object, and effectively matching an attention dimension of the target object, so that recommendation efficiency and recommendation accuracy can be effectively improved.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely embodiments of this disclosure and are not intended to limit the protection scope of this disclosure. Any modification, equivalent replacement, or improvement made without departing from the spirit and range of this disclosure shall fall within the protection scope of this disclosure.

What is claimed is:

1. A method of artificial intelligence-based recommendation, the method comprising:
obtaining an object feature of a target object;
obtaining, from a first information item, respective information features in one or more dimensions;
performing an attention processing on the respective information features in the one or more dimensions based on the object feature, to obtain weights of the respective information features in the one or more dimensions;
performing fusion processing on the respective information features in the one or more dimensions based on the weights of the respective information features in the one or more dimensions, to obtain an attention information feature of the first information item;
determining a first feature similarity between the object feature and the attention information feature; and
determining, based on the first feature similarity, whether to recommend the first information item to the target object.

2. The method according to claim 1, wherein the obtaining the object feature comprises:
obtaining object data of the target object;
performing a compression coding on the object data, to obtain an original object feature of the object data; and
performing a first full connection processing on the original object feature, to obtain the object feature of the target object.

3. The method according to claim 1, wherein the obtaining the respective information features comprises:
obtaining respective information data in the one or more dimensions of the first information item;
performing respective compression coding on the respective information data in the one or more dimensions, to obtain respective original information features in the one or more dimensions; and
performing respective second full connection processing on the respective original information features in the one or more dimensions, to obtain the respective information features in the one or more dimensions.

4. The method according to claim 1, wherein the performing the attention processing comprises:
obtaining a transposed matrix of the object feature;
performing respective dot product processing on the transposed matrix and the respective information features in the one or more dimensions, to obtain respective dot product results in the one or more dimensions; and
performing a normalization processing on the respective dot product results in the one or more dimensions, to obtain the weights of the respective information features in the one or more dimensions.

5. The method according to claim 1, wherein the determining whether to recommend comprises at least one of:
when the first feature similarity exceeds a first feature similarity threshold, determining to recommend the first information item to the target object; and/or
based on the first feature similarity of the first information item, sorting a plurality of information items including the first information item in a descending order, one or more top ranking information items in the plurality of information items that are sorted in the descending order being recommended to the target object.

6. The method according to claim 1, wherein the method of artificial intelligence-based recommendation is implemented using a first trained recommendation model, the first trained recommendation model comprises a first trained network for obtaining the object feature and a second trained network for obtaining the respective information features, a training to obtain the first trained recommendation model comprises:
obtaining at least a first sample pair that includes a first object sample and a first information item sample;
performing forward propagation of the first sample pair in a first recommendation model for training, to obtain a prediction indicator of the first information item sample, the first recommendation model for training comprising a first network to be trained to obtain the object feature and a second network to be trained to obtain the respective information features;
obtaining a first information item augmentation feature based on the first information item sample;
obtaining a second information item augmentation feature based on a second information item sample that is different from the first information item sample;
performing forward propagation on the first information item augmentation feature of the first information item sample in a first auxiliary feature model that is configured according to the second network to obtain a first deep information item augmentation feature of the first information item sample;
performing forward propagation on the second information item augmentation feature of the second information item sample in a second auxiliary feature model that is configured according to the second network to obtain a second deep information item augmentation feature of the second information item sample;
determining a self-similarity of the first information item sample and a mutual-similarity of the first information item sample and the second information item sample based on the first deep information item augmentation feature of the first information item sample and the second deep information item augmentation feature of the second information item sample;
determining a first loss based on the prediction indicator of the first information item sample;
determining a second loss based on the self-similarity of the first information item sample and the mutual-similarity of the first information item sample and the second information item sample;
performing a fusion processing on the first loss and the second loss, to obtain a comprehensive loss; and
updating at least a parameter of the first recommendation model for training based on the comprehensive loss.

7. The method according to claim 6, wherein the determining the first loss comprises:
obtaining a label indicator of the first information item sample; and
performing a cross-entropy processing on the label indicator and the prediction indicator, to obtain the first loss.

8. The method according to claim 6, wherein the training is based on a set of information item samples including the first information item sample, the determining the second loss comprises:
determining a plurality of mutual-similarities of the first information item sample to other information item samples in the set;
performing a summation processing on the plurality of mutual-similarities, to obtain a first summation result corresponding to the first information item sample;
obtaining a ratio associated with the first information item sample, the ratio being positively correlated with the self-similarity of the first information item sample and being negatively correlated with the first summation result;
performing a fusion processing on a plurality of ratios associated with the information item samples in the set, to obtain a first fusion result; and
obtaining the second loss that is negatively correlated with the first fusion result.

9. The method according to claim 6, wherein:
the obtaining the first information item augmentation feature comprises:
obtaining first respective information sample data of the first information item sample in the one or more dimensions; and
obtaining the first information item augmentation feature based on the first respective information sample data of the first information item sample in the one or more dimensions; and
the obtaining the second information item augmentation feature comprises:
obtaining second respective information sample data of the second information item sample in the one or more dimensions; and
obtaining the second information item augmentation feature based on the second respective information sample data in the one or more dimensions.

10. The method according to claim 9, wherein the obtaining the second information item augmentation feature comprises:
obtaining an original information feature of the second information item sample based on the second respective information sample data in the one or more dimensions; and
performing a data augmentation processing on the original information feature of the second information item sample, to obtain the second information item augmentation feature of the second information item sample.

11. The method according to claim 9, wherein the obtaining the first information item augmentation feature comprises:
obtaining original information item features of the first information item sample based on the first respective information sample data of the first information item sample in the one or more dimensions;
performing a first data augmentation processing on the original information item features of the first information item sample, to obtain a first information augmentation feature of the first information item sample;
performing a second data augmentation processing on the original information item features of the first information item sample, to obtain a second information augmentation feature of the first information item sample; and
forming the first information item augmentation feature of the first information item sample by using the first information augmentation feature and the second information augmentation feature.

12. The method according to claim 11, wherein the performing the first data augmentation processing comprises:
obtaining a seed dimension from the one or more dimensions;
obtaining respective dimension similarities between the seed dimension and other dimensions in the one or more dimensions;
sorting the other dimensions in the one or more dimensions in a descending order based on the respective dimension similarities;
using top ranking dimensions in the other dimensions that are sorted in the descending order as masking dimensions of the first information item sample;
determining respective masking results of field features of respective masking dimensions based on a first probability;
performing conditional deletions of the field features from the original information item features based on the respective masking results, a field feature being deleted from the original information item features when a masking result of the field feature indicates that the field feature is discarded; and
using remaining features of the original information item features obtained after the conditional deletions as the first information augmentation feature of the first information item sample.

13. The method according to claim 6, wherein the determining the self-similarity and the mutual-similarity comprises:
determining the self-similarity of the first information item sample based on the first deep information item augmentation feature of the first information item sample; and
determining the mutual-similarity of the first information item sample and the second information item sample based on the first deep information item augmentation feature of the first information item sample and the second deep information item augmentation feature of the second information item sample.

14. The method according to claim 13, wherein the first deep information item augmentation feature of the first information item sample comprises a first deep information augmentation feature and a second deep information augmentation feature, the determining the self-similarity comprises:
obtaining a first cosine similarity between the first deep information augmentation feature and the second deep information augmentation feature; and
obtaining the self-similarity that is positively correlated with the first cosine similarity.

15. The method according to claim 13, wherein the first deep information item augmentation feature of the first information item sample comprises a first deep information augmentation feature; the second deep information item augmentation feature of the second information item sample comprises a third deep information augmentation feature; and the determining the mutual-similarity comprises:
obtaining a second cosine similarity between the first deep information augmentation feature of the first information item sample and the third deep information augmentation feature of the second information item sample; and
obtaining the mutual-similarity that is positively correlated with the second cosine similarity.

16. An apparatus for artificial intelligence-based recommendation, comprising processing circuitry configured to:
obtain an object feature of a target object;
obtain, from a first information item, respective information features in one or more dimensions;
perform an attention processing on the respective information features in the one or more dimensions based on the object feature, to obtain weights of the respective information features in the one or more dimensions;
perform fusion processing on the respective information features in the one or more dimensions based on the weights of the respective information features in the one or more dimensions, to obtain an attention information feature of the first information item;
determine a first feature similarity between the object feature and the attention information feature; and
determine, based on the first feature similarity, whether to recommend the first information item to the target object.

17. The apparatus according to claim 16, wherein the processing circuitry is configured to:
obtain object data of the target object;
perform a compression coding on the object data, to obtain an original object feature of the object data; and
perform a first full connection processing on the original object feature, to obtain the object feature of the target object.

18. The apparatus according to claim 16, wherein the processing circuitry is configured to:
obtain respective information data in the one or more dimensions of the first information item;
perform respective compression coding on the respective information data in the one or more dimensions, to obtain respective original information features in the one or more dimensions; and
perform respective second full connection processing on the respective original information features in the one or more dimensions, to obtain the respective information features in the one or more dimensions.

19. The apparatus according to claim 16, wherein the processing circuitry is configured to:
obtain a transposed matrix of the object feature;
perform respective dot product processing on the transposed matrix and the respective information features in the one or more dimensions, to obtain respective dot product results in the one or more dimensions; and
perform a normalization processing on the respective dot product results in the one or more dimensions, to obtain the weights of the respective information features in the one or more dimensions.

20. A non-transitory computer-readable storage medium storing instructions which when executed by at least one processor cause the at least one processor to perform:
obtaining an object feature of a target object;
obtaining, from a first information item, respective information features in one or more dimensions;
performing an attention processing on the respective information features in the one or more dimensions based on the object feature, to obtain weights of the respective information features in the one or more dimensions;
performing fusion processing on the respective information features in the one or more dimensions based on the weights of the respective information features in the one or more dimensions, to obtain an attention information feature of the first information item;
determining a first feature similarity between the object feature and the attention information feature; and
determining, based on the first feature similarity, whether to recommend the first information item to the target object.
